(19) United States
(12) Patent Application Publication
(10) Pub. No.: US 2016/0084870 A1
(43) Pub. Date: Mar. 24, 2016

(54) SENSOR

(71) Applicant: Panasonic Intellectual Property Management Co., Ltd., Osaka (JP)

(72) Inventors: Takashi Imanaka, Osaka (JP); Khai Jun Kek, Singapore (SG); Rie Okamoto, Osaka (JP); Tsuyoshi Sakaue, Fukui (JP); Hiroshi Nakatsuka, Osaka (JP)

(21) Appl. No.: 14/785,605

(22) PCT Filed: Apr. 17, 2014
(86) PCT No.: PCT/JP2014/002188

§ 371 Date: Oct. 19, 2015

(30) Foreign Application Priority Data
Apr. 26, 2013 (JP) 2013-093457
Feb. 20, 2014 (JP) 2014-030314

(51) Int. Cl. G01P 15/08; G01C 19/5783; G01L 19/06

(52) U.S. Cl. CPC G01P 15/08; G01L 19/06; G01C 19/5783

(57) ABSTRACT

A sensor includes a first substrate, a supporter connected to the first substrate, a weight facing the first substrate, a beam of which first end is connected to the supporter and of which second end is connected to the weight, a second substrate facing the weight, and a first projection disposed on the first substrate. This senor allows effectively preventing the beam from a breakage caused by the beam twisted due to a rotation of the weight when an impact is applied to the sensor. The sensor thus can improve anti-impact property.

### TECHNICAL FIELD

The present invention relates to sensors, such as inertia sensors including an acceleration sensor and an angular velocity sensor to be used in vehicles, navigation devices, or portable terminals, and to distortion sensors and barometric sensors.

### BACKGROUND ART

FIG. 24 is a sectional view of conventional acceleration sensor 1 disclosed in PTL 1. Sensor 1 includes substrate 2, supporter 3 disposed on an upper surface of substrate 2, weight 4 facing an upper surface of substrate 2, beam 5 connected to supporter 3 and weight 4, projection 6 formed on a lower surface of weight 4. One end of beam 5 is connected to supporter 3 while another end of beam 5 is connected to weight 4.

FIGS. 25A and 25B are schematic sectional views of sensor 1 viewing from direction 1A in FIG. 24. Sensor 1 shown in FIG. 25A receives no acceleration, but sensor 1 shown in FIG. 25B receives an excessive impact applied along an X-axis. As shown in FIG. 25B, the excessive impact applied along the X-axis causes weight 4 to rotate about a Y-axis, and may twist and break beam 5.

### CITATION LIST

### Patent Literature

PTL 1: Japanese Patent Laid-Open Publication No.2007-132863

### SUMMARY

A sensor includes a first substrate, a supporter connected to the first substrate, a weight facing the first substrate, a beam having a first end connected to the supporter and having a second end connected to the weight, a second substrate facing the weight, and a projection provided on the first substrate. This sensor effectively prevents the beam from a breakage caused by a twist of the beam when an impact applied to the sensor causes the weight to rotate. The sensor thus improves its impact resistance.

### BRIEF DESCRIPTION OF DRAWINGS

FIG. 1A is a top view of a sensor in accordance with Exemplary Embodiment 1.

FIG. 1B is a sectional view of the sensor on line 1B-1B shown in FIG. 1A.

FIG. 2 is a circuit diagram of the sensor in accordance with Embodiment 1.

FIG. 3A is a sectional view of the sensor on line 3A-3A shown in FIG. 1B.

FIG. 3B is a sectional view of a comparative example of a sensor.

FIG. 4A shows characteristics of the sensor in accordance with Embodiment 1.

FIG. 4B is a sectional view of another sensor in accordance with Embodiment 1.

FIG. 5A is a sectional view of a sensor in accordance with Exemplary Embodiment 2.

FIG. 5B is a sectional view of the sensor on line 5B-5B shown in FIG. 5A.

FIG. 5C is a sectional view of another sensor in accordance with Embodiment 2.

FIG. 6A is a top view of a sensor in accordance with Exemplary Embodiment 3.

FIG. 6B is a sectional view of the sensor on line 6B-6B shown in FIG. 6A.

FIG. 7A is a sectional view of the sensor in accordance with Embodiment 3.

FIG. 7B is a sectional view of the sensor in accordance with Embodiment 3.

FIG. 7C is a sectional view of another sensor in accordance with Embodiment 3.

FIG. 8A is a top view of still another sensor in accordance with Embodiment 3.

FIG. 8B is a sectional view of the sensor on line 8B-8B shown in FIG. 8A.

FIG. 8C is a sectional view of a further sensor in accordance with Embodiment 3.

FIG. 9A is a top view of a sensor in accordance with Exemplary Embodiment 4.

FIG. 9B is a sectional view of the sensor on line 9B-9B shown in FIG. 9A.

FIG. 10 is a circuit diagram of the sensor in accordance with Embodiment 4.

FIG. 11A is a sectional view of the sensor on line 11A-11A shown in FIG. 9B.

FIG. 11B is a sectional view of another comparative example of a sensor.

FIG. 12A is a sectional view of the sensor in accordance with the fourth embodiment.

FIG. 12B is a sectional view of a further comparative example of a sensor.

FIG. 13A is a sectional view of a sensor in accordance with Exemplary Embodiment 5.

FIG. 13B is a sectional view of the sensor on line 13B-13B shown in FIG. 13A.

FIG. 14A is a sectional view of another sensor in accordance with Embodiment 5.

FIG. 14B is a sectional view of the sensor on line 14B-14B shown in FIG. 14A.

FIG. 15A is a sectional view of still another sensor in accordance with Embodiment 5.

FIG. 15B is a sectional view of the sensor on ling 15B-15B shown in FIG. 15A.

FIG. 16A is a top view of a sensor in accordance with Exemplary Embodiment 6.

FIG. 16B is a sectional view of the sensor on ling 16B-16B shown in FIG. 16A.

FIG. 17A is a sectional view of the sensor in accordance with Embodiment 6.

FIG. 17B is a sectional view of the sensor in accordance with Embodiment 6.

FIG. 18A is a top view of another sensor in accordance with Embodiment 6.

FIG. 18B is a sectional view of the sensor on ling 18B-18B shown in FIG. 18A.

FIG. 19A is a sectional view of the sensor shown in FIGS. 18A and 18B.

FIG. 19B is a sectional view of the sensor shown in FIGS. 18A and 18B.

FIG. 19C is a sectional view of still another sensor in accordance with Embodiment 6.

FIG. 20A is a top view of a sensor in accordance with Exemplary Embodiment 7.

FIG. 20B is a sectional view of the sensor on line 20B-20B shown in FIG. 20A.

FIG. 21A is a sectional view of the sensor on line 21A-21A shown in FIG. 20A.

FIG. 21B is a sectional view of the sensor on line 21B-21B shown in FIG. 20A.

FIG. 21C is a sectional view of the sensor on line 21C-21C shown in FIG. 20A.

FIG. 22 is a top view of another sensor in accordance with Embodiment 7.

FIG. 23 is a top view of still another sensor in accordance with Embodiment 7.

FIG. 24 is a sectional view of a conventional sensor.

FIG. 25A is a sectional view of the conventional sensor.

FIG. 25B is a sectional view of the conventional sensor.

### DETAILED DESCRIPTION OF PREFERRED EMBODIMENTS

### Exemplary Embodiment 1

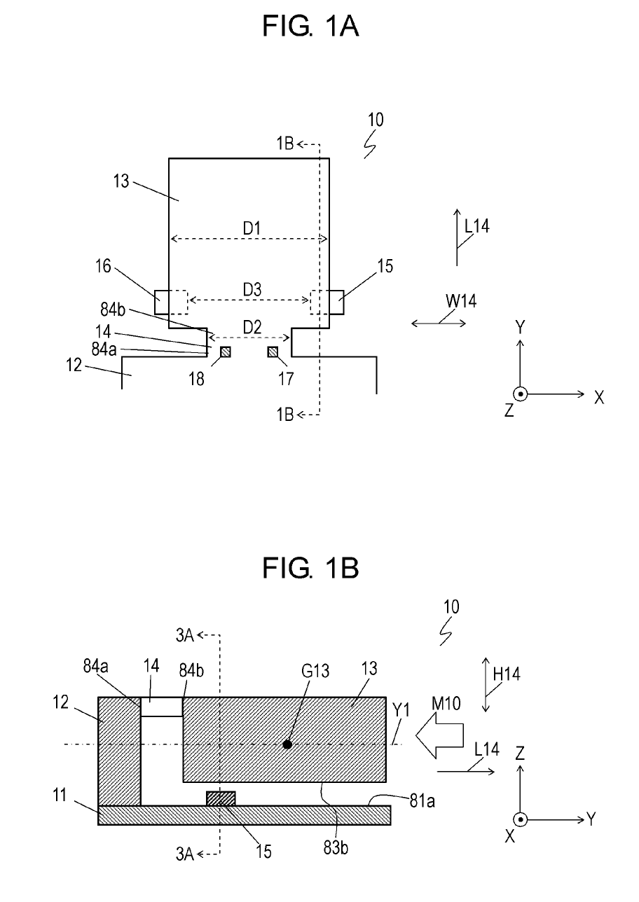

FIG. 1A is a top view of sensor 10 in accordance with Exemplary Embodiment 1. FIG. 1B is a sectional view of sensor 10 on line 1B-1B shown in FIG. 1A. Sensor 10 in accordance with Embodiment 1 is an acceleration sensor for detecting an acceleration.

Sensor 10 includes substrate 11, supporter 12 connected to upper surface 81a of substrate 11, weight 13 having lower surface 83b facing upper surface 81a of substrate 11, beam 14 connecting supporter 12 to weight 13, and projections 15 and 16 provided on upper surface 81a of substrate 11. Beam 14 has first end 84a connected to supporter 12 and second end 84b opposite to first end 84a, and extends from first end 84a to second end 84b in extending direction L14. Weight 13 is connected to second end 84b of beam 14. Weight 13 has width D1 in width direction W14 that is perpendicular to extending direction L14 and is parallel with upper surface 81a of substrate 11. Beam 14 has width D2 in width direction W14. Width D1 is larger than width D2. Interval D3 is a distance between projections 15 and 16 in width direction W14. Interval D3 is larger than width D2 of beam 14 and smaller than width D1 of weight 13. Interval D13 is a distance between respective surfaces of projections 15 and 16 facing each other.

A Y-axis parallel to extending direction L14, an X-axis parallel to width direction W14, and a Z-axis which is height direction H14 perpendicular to extending direction L14 (X-axis) and width direction W14 (Y-axis) are defined. According to Embodiment 1, sensor 10 detects an acceleration in a direction of the Z-axis. When an impact is applied in a direction of the X-axis perpendicular to the Z-axis, projections 15 and 16 prevent weight 13 from rotating about the Y-axis, thereby preventing beam 14 from being broken.

A structure of sensor 10 will be detailed hereinafter. Substrate 11, supporter 12, weight 13, beam 14, projections 15 and 16 are made of silicon, fused quartz, or aluminum oxide. Silicon is preferable since it adopts a micro-processing technique for obtaining sensor 10 having a small size.

Substrate 11 and supporter 12 are bonded together with adhesive, or by a metal bonding method, or an anode bonding method. The adhesive may be epoxy-based resin or silicone-based resin. The silicone-based resin as the adhesive decreases stress applied to substrate 11 and supporter 12 with the adhesive curing.

Beam 14 has a thickness smaller than that of weight 13 in height direction H14. This structure allows an external acceleration to displace weight 13, and generate distortion in beam 14. This distortion is detected to detect the acceleration.

Detectors 17 and 18 for detecting acceleration are provided on beam 14. Detectors 17 and 18 measure the acceleration by a distortion-sensitive resistance method or a capacitance method. A piezoelectric resistor in the distortion-sensitive resistance method improves sensitivity of sensor 10. A thin-film resistance method with an oxide-film distortion-sensitive resistor in the distortion-sensitive resistance method improves temperature characteristics of sensor 10.

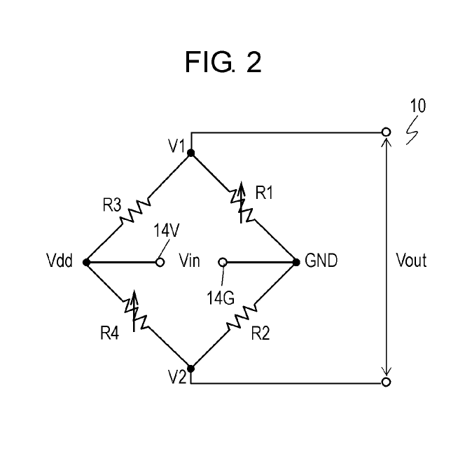

FIG. 2 is a circuit diagram of sensor 10 including detectors 17 and 18 employ the distortion-sensitive resistance method. Detector 17 includes resistor R1. Detector 18 includes resistor R4. Resistors R2 and R3 are provided on supporter 12. Resistors R1, R2, R3, and R4 are connected at nodes Vdd, GND, V1, and V2 to form a bridge circuit. A voltage applied across nodes Vdd and GND opposite to each other while a voltage difference Vout across nodes V1 and V2 opposite to each other is detected so as to detect an acceleration applied to sensor 10.

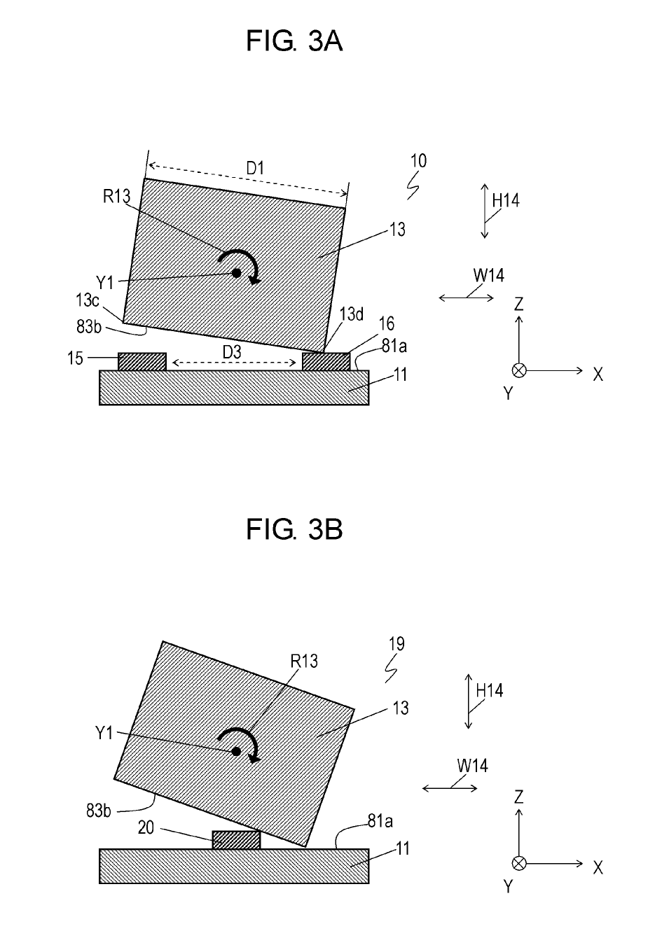

FIG. 3A is a sectional view of sensor 10 on line 3A-3A shown in FIG. 1B, viewing in direction M10 shown in FIG. 1B. Weight 13 has corners 13c and 13d disposed above projections 15, respectively. Upon having an impact applied in a positive direction of the X-axis to apply an excessive acceleration, weight 13 rotates about axis Y1 which extends through the center G13 of gravity and which is parallel to the Y-axis, such that lower surface 83b of weight 13 approaches projection 16 and leaves projection 15, thereby twisting beam 14. At this moment, corner 13d of weight 13 contacts projection 16, thereby disabling weight 13 to further rotate in direction R13. When weight 13 rotates in a direction opposite to direction R13, corner 13c of weight 13 contacts projection 15, thereby disabling weight 13 to further rotate.

FIG. 3B is a sectional view of a comparative example, sensor 19. In FIG. 3B, components identical to those of sensor 10 shown in FIG. 3A in accordance with Embodiment 1 are denoted by the same reference numerals.

Sensor 19, the comparative example, includes projection 20 provided on upper surface 81a of substrate 11 instead of projections 15 and 16 of sensor 10 shown in FIG. 3A. Projection 20 is disposed under a center of weight 13. When an excessive acceleration is applied in a positive direction of the X-axis due to an impact, weight 13 rotates in direction R13. At this moment, weight 13 rotates until lower surface 83b of weight 13 contacts projection 20. This rotation twists thin beam 14 supporting weight 13 to generate excessive stress in beam 14, and may break beam 14.

Interval D3 between projection 15 and projection 16 in width direction W14 is larger than width D2 (FIG. 1A) of beam 14 in width direction W14, and is smaller than width D1 of weight 13 in width direction W14. Interval D3 is a distance between respective surfaces of projections 15 and 16 facing each other. This structure effectively reduces the stress caused by the rotation of weight 13 and generated in beam 14.

As shown FIGS. 1A and 3A, a portion of projection 15 and a portion of projection 16 are preferably exposed from weight 13 in a top view. This structure allows corners 13c and 13d to contact centers of upper surfaces of projections 15 and 16, respectively, as shown in FIG. 3A, thereby restricting the rotation of weight 13 and the twist of beam 14.

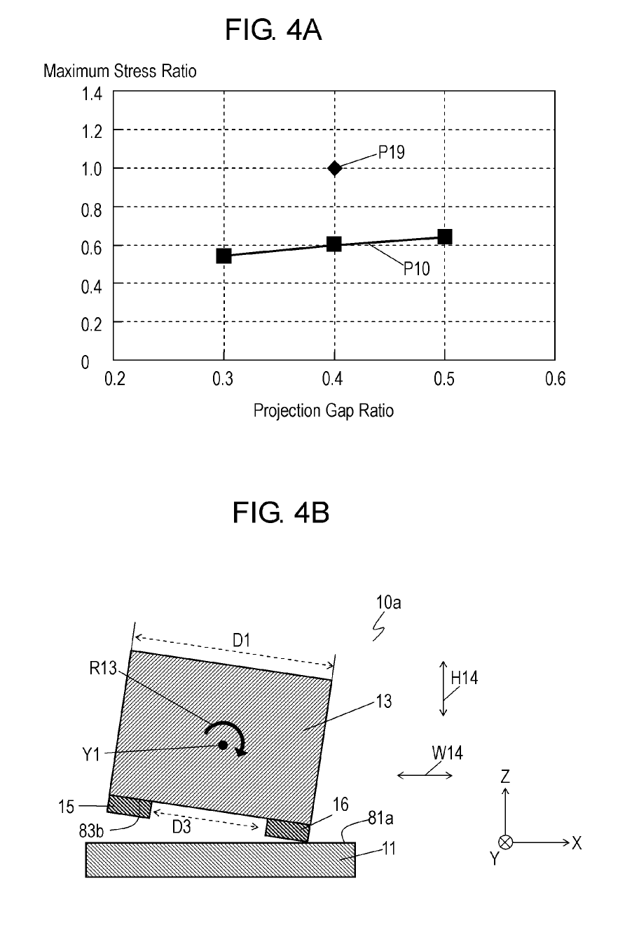

FIG. 4A shows profile P10 of sensor 10 in accordance with Embodiment 1, particularly showing an advantage of small stress. FIG. 4A also shows profile P19 of sensor 19 of the comparative example. In FIG. 4A, the horizontal axis represents a projection gap ratio, and the vertical axis represents a maximum stress ratio. The projection gap ratio (F2/H1) is a ratio of a distance (H2) between lower surface 83b of weight 13 and each of the upper surfaces of projections 15 and 16 to a distance (H1) between upper surface 81a of substrate 11 and lower surface 83b of weight 13. The maximum stress ratio (S2/S1) is a ratio of a maximum stress (S2) generated in beam 14 of sensor 10 shown in FIG. 3A in accordance with Embodiment 1 to a maximum stress (S1) generated in beam 14 of sensor 19, the comparative example. As shown in FIG. 4A, in the case that the projection gap ratio is 0.4, the maximum stress applied to beam 14 of sensor 10 is about 60% of the maximum stress applied to beam 14 of sensor 19 of the comparative example, thus reducing the stress by about 40%. A smaller projection gap ratio (i.e. increase the heights of projections 15 and 16) reduces the stress more, but reduces a moving range of weight 13, accordingly reducing a range of an acceleration to be detected. The projection gap ratio preferably ranges from 0.3 to 0.5.

FIG. 4B is a sectional view of another sensor 10a in accordance with Embodiment 1. In FIG. 4B, components identical to those of sensor 10 shown in FIG. 3A are denoted by the same reference numerals. Sensor 10a shown in FIG. 4B includes projections 15 and 16 provided on lower surface 83b of weight 13 instead of on upper surface 81a of substrate 11, so that projections 15 and 16 face upper surface 81a of substrate 11. In this sensor 10a, interval D3 between projections 15 and 16 in width direction W14 is larger than width D2 of beam 14, and is smaller than width D1 of weight 13, so that the stress caused by the twist of beam 14 caused by the rotation of weight 13 and generated in beam 14 can be reduced. Projections 15 and 16 provided on lower surface 83b of weight 13 maintain the relative positional relation among projections 15 and 16 and weight 13 even if projections 15 and 16 and weight 13 have positions changing due to variations in manufacturing processes thereof. As a result, weight 13 is positively prevented from further rotation or displacement.

### Exemplary Embodiment 2

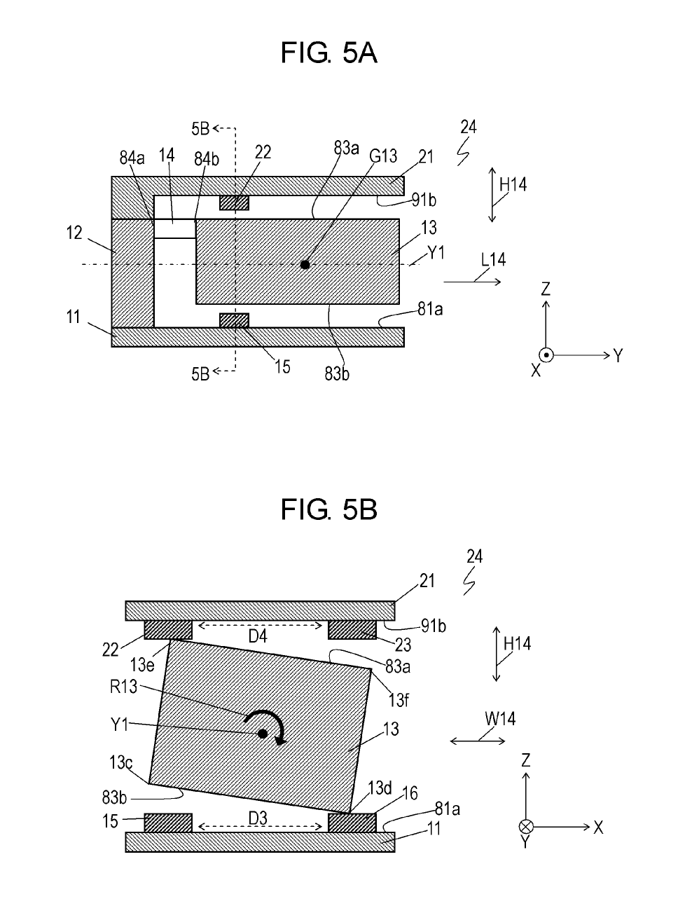

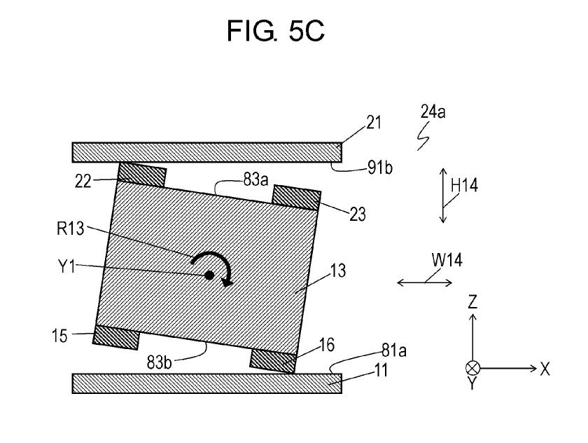

FIG. 5A is a sectional view of sensor 24 in accordance with Exemplary Embodiment 2. FIG. 5B is a sectional view of sensor 24 cut along line 5B-5B shown in FIG. 5A. In FIGS. 5A and 5B, components identical to those of sensor 10 shown in FIGS. 1A-3A are denoted by the same reference numerals. Sensor 24 further includes substrate 21 connected to supporter 12, and projections 22 and 23 provided on substrate 21 in addition to the structural elements of sensor 10 in accordance with Embodiment 1. Substrate 21 is rigidly mounted and is not movable with respect to substrate 11. Substrate 21 has lower surface 91b facing upper surface 83a of weight 13. Weight 13 is disposed between upper surface 81a of substrate 11 and lower surface 91b of substrate 21. Projections 22 and 23 are disposed on lower surface 91b of substrate 21 and at positions symmetrical to those of projections 15 16 on upper surface 81a of substrate 11 with respect to weight 13, respectively. In other words, interval D4 between projections 22 and 23 in width direction W14 is equal to interval D3 between projections 15 and 16 in width direction W14. Interval D4 is a distance between surfaces of projections 15 and 16 facing each other. Interval D4 between projections 22 and 23 is larger than width D2 of beam 14 in width direction W14, and is smaller than width D1 of weight 13 in width direction W14 (refer to FIG. 1A). Weight 13 has corners 13e and 13f located under projections 22 and 23, respectively. This structure allows corners 13c and 13d of lower surface 83b of weight 13 to contact projections 15 and 16, respectively, and yet, allows corners 13e and 13f of upper surface 83a of weight 13 to contact projections 22 and 23, respectively, so that weight 13 can be more positively prevented from further rotating, and thus beam 14 can be prevented from twisting.

FIG. 5C is a sectional view of another sensor 24a in accordance with Embodiment 2. In FIG. 5C, components identical to those of sensor 24 shown in FIG. 5B are denoted by the same reference numerals. Sensor 24a shown in FIG. 5C includes projections 22 and 23 on lower surface 83b of weight 13 instead of on upper surface 81a of substrate 11, so that projections 22 and 23 face lower surface 91b of substrate 21. Projections 15 and 16 are disposed on lower surface 83b of weight 13 instead of on upper surface 81a of substrate 11, so that projections 15 and 16 face upper surface 81a of substrate 11. In sensor 24a, interval D3 between projections 15 and 16 in width direction W14 is larger than width D2 of beam 14 in width direction W14, and is smaller than width D1 of weight 13 in width direction W14, thereby reducing stress due to the twisting of beam 14 caused by the rotation of weight 13. Projections 22 and 23 provided on upper surface 83a of weight 13 and projections 15 and 16 provided on lower surface 83b of weight 13 maintain the relative position among projections 15, 16, 22, and 23 and weight 13 even if respective positions of projections 15, 16, 22, and 23 and weight 13 change due to variations in manufacturing processes. As a result, weight 13 is positively prevented from further rotation or displacement.

### Exemplary Embodiment 3

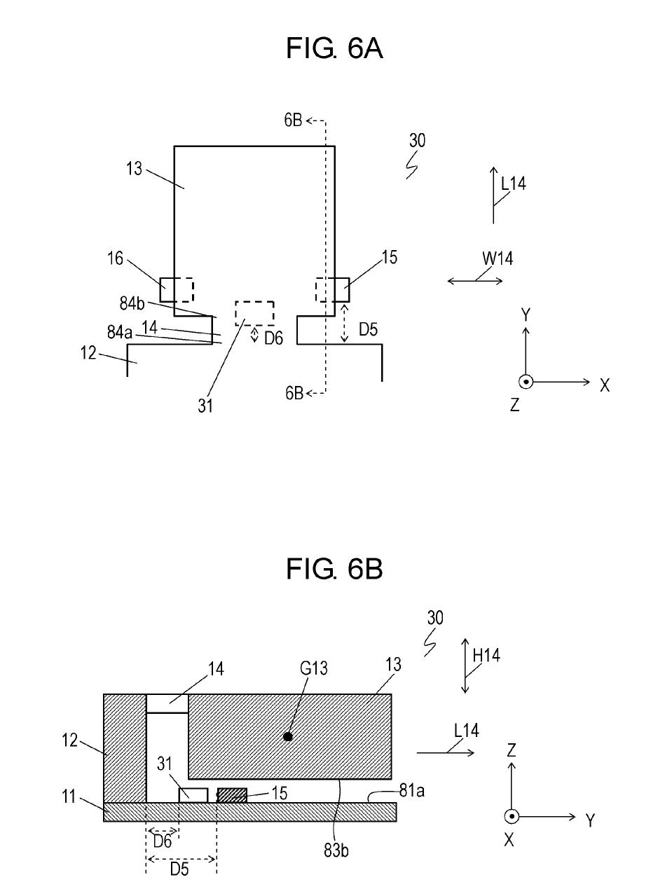

FIG. 6A is a top view of sensor 30 in accordance with Exemplary Embodiment 3. FIG. 6A does not show substrate 11. FIG. 6B is a sectional view of sensor 30 along line 6B-6B shown in FIG. 6A. In FIGS. 6A and 6B, components identical to those of sensor 10 shown in FIGS. 1A-3A in accordance with Embodiment 1 are denoted by the same reference numerals.

Sensor 30 further includes projection 31 disposed on upper surface 81a of substrate 11 in addition to the projections of sensor 10 in accordance with Embodiment 1. Projection 31 is located between projection 15 and projection 16 in width direction W14. Projection 31 prevents weight 13 from an excessive displacement along the Z-axis.

An impact applied to sensor 30 causes weight 13 to contact projections 15 and 16 and rotate about center G13 of gravity of weight 13. Distance D5 between supporter 12 and each of projections 15 and 16 in extending direction L14 is larger than distance D6 between projection 31 and supporter 12 in extending direction L14. Projections 15 and 16 are disposed closer to center G13 of gravity of weight 13 than projection 31 is. This structure prevents thin beam 14 from being broken due to the rotation of weight 13 about center G13 of gravity. In the case that projections 15 and 16 are located at a position from center G13 of gravity in extending direction L14, a movable space of weight 13 in directions of the Z-axis becomes smaller. Projections 15, 16 may preferably be disposed between supporter 12 and center G13 of gravity.

Projection 31 located between supporter 12 and each of projections 15 and 16 positively prevents weight 13 from being displaced excessively in a direction of the Z-axis.

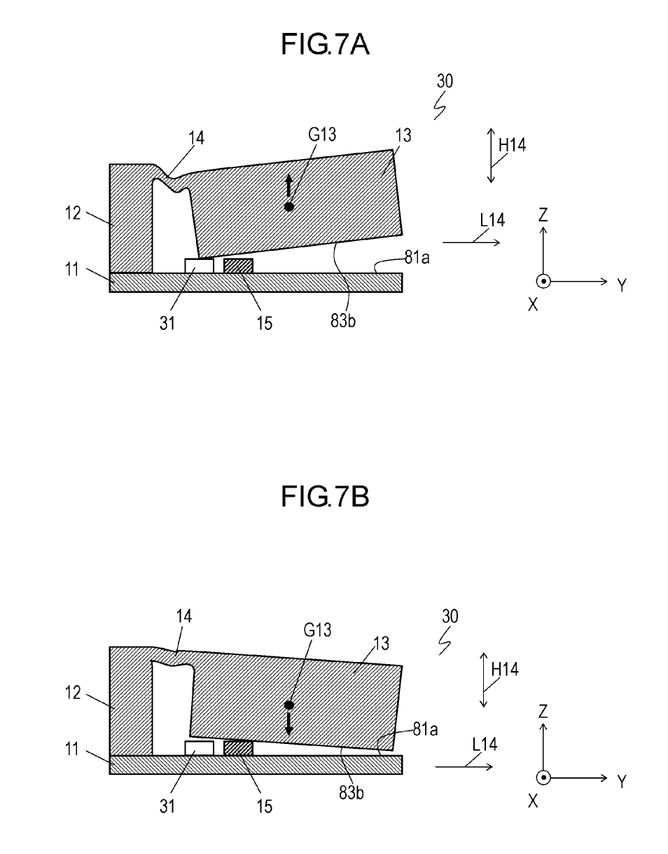

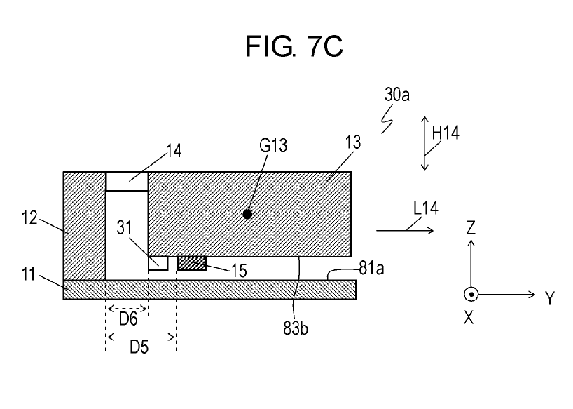

FIGS. 7A and 7B are sectional views of sensor 30 for illustrating that weight 13 is displaced in a direction of the Z-axis due to an excessive impact applied to sensor 30 in the direction of the Z-axis. FIG. 7A shows that the excessive impact is applied to sensor 30 in a positive direction along the Z-axis, namely, from the lower section to the upper section of sensor 30. In this case, since projection 31 is disposed closer to supporter 12 than projections 15 and 16, a corner of weight 13 contacts an upper surface of projection 31, thereby preventing weight 13 effectively from excessively being displaced in the positive direction of the Z-axis. FIG. 7B shows that the excessive impact is applied to sensor 30 in a negative direction of the Z-axis, namely, from the upper section to the lower section of sensor 30. In this case, since projections 15 and 16 are disposed closer to center G13 of gravity than projection 31, lower surface 83b of weight 13 contacts projections 15 and 16, thereby preventing weight 13 effectively from excessively being displaced in the negative direction of the Z-axis.

FIG. 7C is a sectional view of another sensor 30a in accordance with Embodiment 3. In FIG. 7C, components identical to those of sensor 30 shown in FIG. 7B are denoted by the same reference numerals. Sensor 30a shown in FIG. 7C includes projections 15, 16 and 31 on lower surface 83b of weight 13 instead of on upper surface 81a of substrate 11, and thus these projections face upper surface 81a of substrate 11. In sensor 30a, relative positional relations among projections 15, 16, and 31, weight 13, and supporter 12 are maintained identical to those of sensor 30, so that weight 13 can be prevented from an excessive rotation or excessive displacement in a direction of the Z-axis. Projections 15, 16, and 31 provided on lower surface 83b of weight 13 maintain the relative position among projections 15, 16, and 31 and weight 13 even if respective positions of projections 15, 16, and 31 and weight 13 change due to variations in manufacturing processes. As a result, weight 13 is positively prevented from an excessive rotation and displacement.

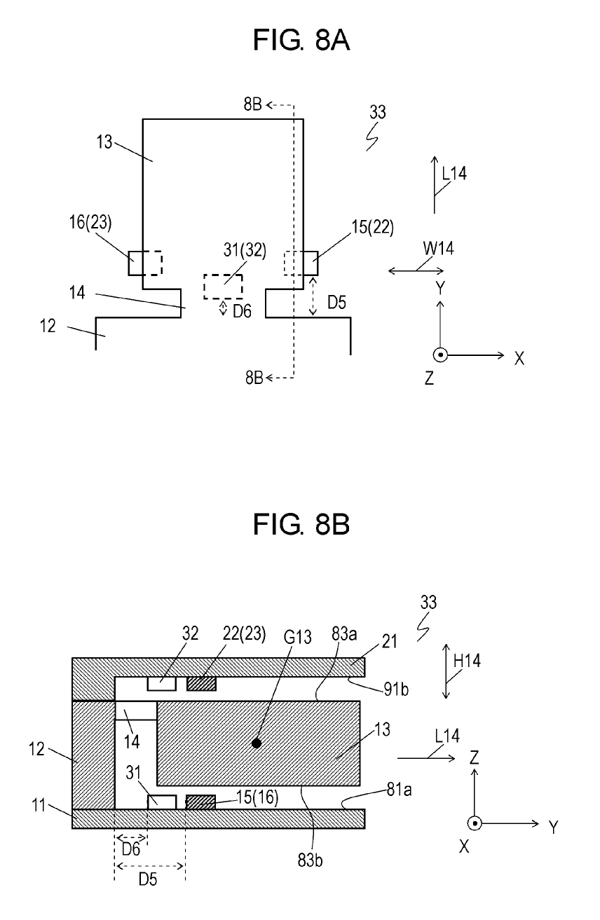

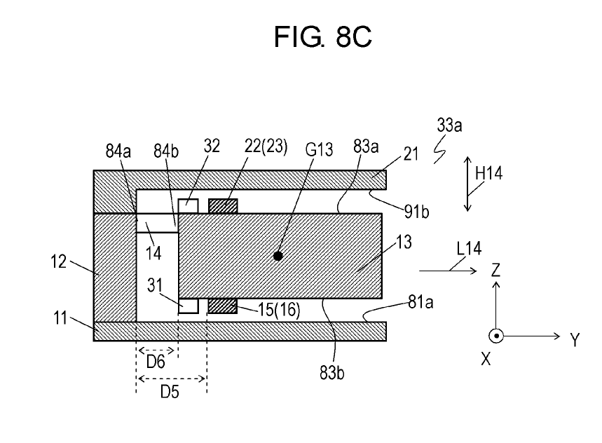

FIG. 8A is a top view of still another sensor 33 in accordance with Embodiment 3. FIG. 8A does not show substrate 11 or 21. FIG. 8B is a sectional view of sensor 33 along line 8B-8B shown in FIG. 8A. In FIGS. 8A and 8B, components identical to those of sensor 30 shown in FIGS. 6A and 6B and sensor 24 shown in FIGS. 5A and 5B in accordance with Embodiment 2 are denoted by the same reference numerals. In sensor 33 shown in FIGS. 8A and 8B, substrate 21 is connected to supporter 12, projections 22 and 23 are disposed on lower surface 91b of substrate 21 facing weight 13, and yet, projection 32 is disposed between projections 22 and 23 in width direction W14. Projections 22, 23, and 32 disposed on lower surface 91b of substrate 21 are symmetrical to projections 15, 16, and 31 disposed on upper surface 81a of substrate 11 with respect to weight 13, respectively. This structure improves anti-impact property since projections 31 and 32 are disposed below weight 13 for preventing weight 13 from rotating caused by an impact applied along a direction of the X-axis, and projections 15, 16, 22, and 23 are disposed above weight 13 for preventing weight 13 from being displaced excessively along a direction of the Z-axis.

FIG. 8C is a sectional view of further sensor 33a in accordance with Embodiment 3. In FIG. 8C, components identical to those of sensor 33 shown in FIGS. 8A and 8B are denoted by the same reference numerals. In sensor 33a shown in FIG. 8C includes projections 15, 16, and 31 disposed not on upper surface 81a of substrate 11 but on lower surface 83b of weight 13 facing upper surface 81a of substrate 11. Projections 22, 23, and 32 are disposed not on lower surface 91b of substrate 21 at but on upper surface 83a of weight 13 facing lower surface 91b of substrate 21. Sensor 33a also prevents weight 13 from the rotation caused by the impact applied in a direction of the X-axis, and prevents weight 13 from the excessive displacement in a direction of the Z-axis. As a result, the anti-impact property can be improved. Projections 22, 23, and 32 provided on upper surface 83a of weight 13 as well as projections 15, 16, and 31 provided on lower surface 83b of weight 13 maintain the relative positions between projections 15, 16, 22, 23, 31, and 33 and weight 13 even if the positions of projections 15, 16, 22, 23, 31, and 33 and weight 13 change due to variations in manufacturing processes. As a result, weight 13 is positively prevented from further rotation or displacement.

### Exemplary Embodiment 4

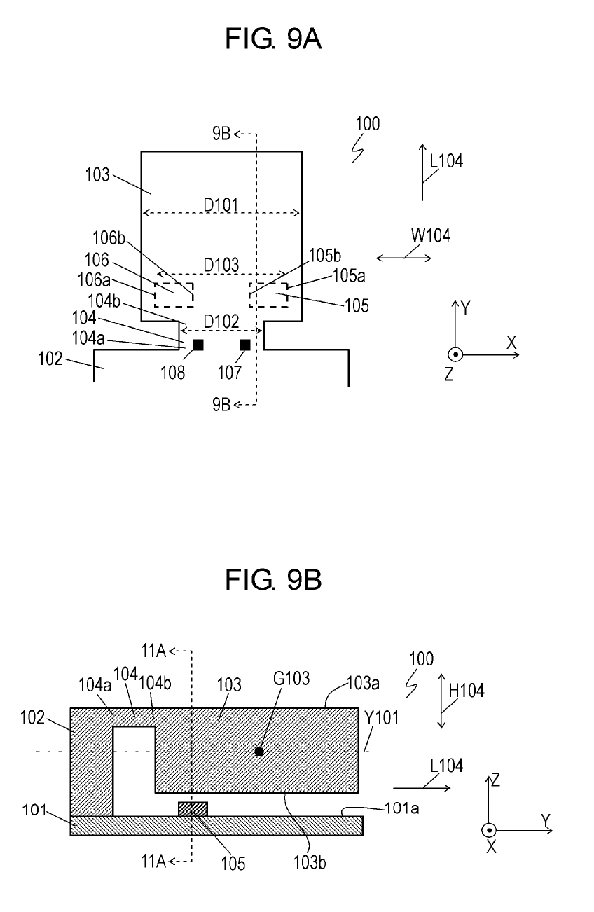

FIG. 9A is a top view of sensor 100 in accordance with Exemplary Embodiment 4. FIG. 9B is a sectional view of sensor 100 along line 9B-9B shown in FIG. 9A. Sensor 100 in accordance with Embodiment 4 is an acceleration sensor for detecting an acceleration.

Sensor 100 includes substrate 101, supporter 102 connected to upper surface 101a of substrate 101, weight 103 having lower surface 103b facing upper surface 101a of substrate 101, beam 104 connecting supporter 102 to weight 103, and projections 105 and 106 provided on upper surface 101a of substrate 101. Beam 104 has one end 104a connected to supporter 102 and another end 104b opposite to one end 104a, and extends from one end 104a to another end 104b in extending direction L104. Weight 103 is connected to another end 104b of beam 104. Lower surface 103b of weight 103 faces upper surface 101a of substrate 101 with a predetermined space between lower surface 103b and upper surface 101a. Weight 13 has width D101 in width direction W104 which is perpendicular to extending direction L104 and which is parallel with upper surface 101a of substrate 101. Beam 104 has width D102 in width direction W104. Width D101 is larger than width D102. Distance D103 between projections 105 and 106 in width direction W104 is larger than width D102 of beam 104 but is smaller than width D101 of weight 103. Projections 105 and 106 have edges 105b and 106b facing each other in width direction W104, respectively. Projection 105 further has edge 105a opposite to edge 105b in width direction W104 while projection 106 has edge 106a opposite to edge 106b in width direction W104. Distance D103 is defined as a distance between edges 105a and 106a of projections 105 and 106 in width direction W104. A Y-axis parallel to extending direction L104, an X-axis parallel to width direction W104, and a Z-axis which is height direction H104 perpendicular to extending direction L104 (X-axis) and width direction W104 (Y-axis) are defined. In accordance with Embodiment 4, sensor 100 detects an acceleration applied in a direction of the Z-axis. Viewing from the above, namely, in a top view, projections 105 and 106 overlaps weight 103.

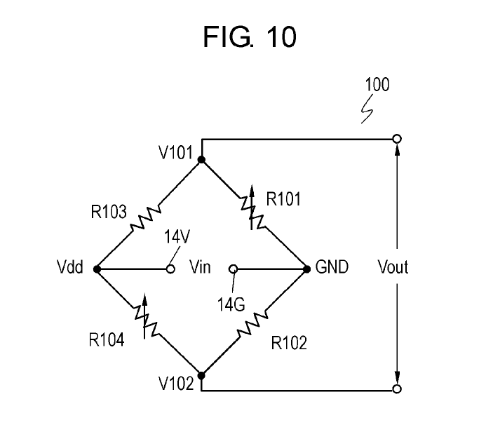

An operation of sensor 100 will be described below. FIG. 10 is a circuit diagram of sensor 100 that employs a distortion-sensitive resistance method in detectors 107 and 108. Detector 107 includes resistor R101 while detector 108 includes resistor R104. Resistors R102 and R103 serving as references are provided on supporter 102. Resistors R101, R102, R103, and R104 are connected at nodes Vdd, GND, V101, and V102 to form a bridge circuit. Voltage Vin is applied across nodes Vdd and GND opposite to each other, thereby detecting voltage Vout across nodes V101 and V102 opposite to each other. An acceleration applied to sensor 100 allows sensor 100 to output voltage Vout in response to the acceleration, so that voltage Vout is detected to detect the acceleration. This structure improves anti-impact property of sensor 100 in accordance with Embodiment 4. The advantages of this improvement will be described below.

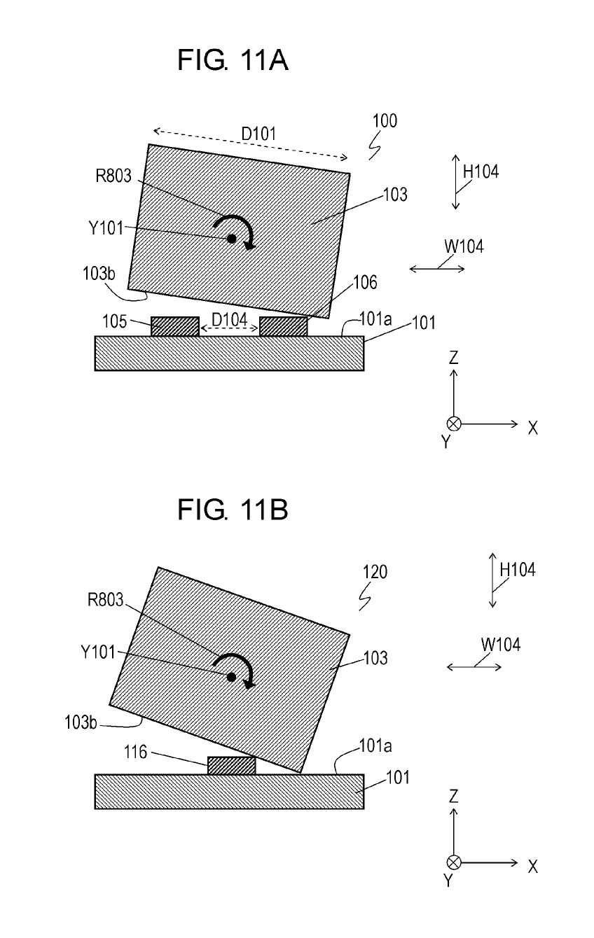

FIG. 11A is a sectional view of sensor 100 along line 11A-11A shown in FIG. 9B. An excessive acceleration caused by an impact is applied to weight 103 in a positive direction of the X-axis, and causes weight 103 to rotate in direction R803 about axis Y101 which is parallel to the Y-axis and which extends through center C103 of gravity of weight 103. At this moment, lower surface 103b of weight 103 contacts projection 106 to prevent weight 103 from further rotating in direction R803. Distance D103 between projections 105 and 106 in width direction W104 is larger than width D102 of beam 104 (refer to FIG. 9A) but is smaller than width D101 of weight 103. Projections 105 and 106 has edges 105b and 106b facing each other in width direction W104, respectively. Projection 105 further has edge 105a opposite to edge 105b in width direction W104 while projection 106 further has edge 106a opposite to end 106b in width direction W104. Distance D103 is defined as a distance between edges 105a and 106a of projections 105 and 106 in width direction W104. The above structure reduces the stress caused by the twisting of beam 104 caused by the rotation of weight 103.

FIG. 11B is a sectional view of another comparative example, sensor 120. In FIG. 11B, components identical to those of sensor 100 shown in FIG. 11A in accordance with Embodiment 4 are denoted by the same reference numerals. The comparative example, sensor 120 shown in FIG. 11B includes projection 116 disposed on upper surface 101a of substrate 101 instead of projections 106 and 105 of sensor 100 shown in FIG. 11A. Projection 116 is disposed under the center of weight 103.

An excessive acceleration applied in the positive direction in a direction of the X-axis causes sensor 120 to rotate in direction R803, similarly to sensor 100 shown in FIG. 11A. At this moment, weight 103 rotates until lower surface 103b contacts projection 116. As a result, a rotation angle in direction R803 becomes larger than that of sensor 100 shown in FIG. 11A, and excessive stress occurs in thin beam 104 supporting weight 103.

As shown in FIGS. 9A and 1A, projections 105 and 106 are preferably not exposed from weight 103 viewing from above, namely, in a top view. This structure allows lower surface 103b of weight 103 to contact the corner of projection 105 or 106, thereby preventing weight 103 from shifting in a negative direction of the X-axis due to the rotation in direction R803. As a result, weight 103 is effectively prevented from further rotating.

Substrate 101, supporter 102, weight 103, beam 104, and projections 105 and 106 of sensor 100 may be made of silicon, fused quartz, or aluminum oxide. Silicon is preferable to provide sensor 100 with a small size by micro-processing technique.

Substrate 101 and supporter 102 are bonded together with adhesive, or by a metal bonding method, or an anode bonding method. The adhesive may be epoxy-based resin or silicone-based resin. The silicone-based resin having a smaller elastic coefficient as the adhesive decreases stress applied to substrate 11 and supporter 12 because of self-curing of the adhesive.

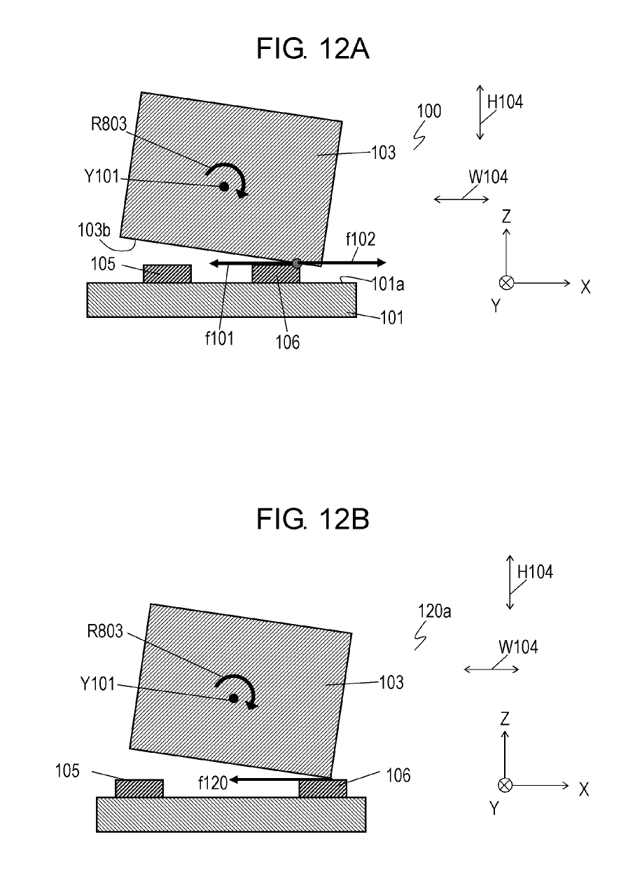

FIG. 12A is a sectional view of sensor 100. As shown in FIG. 12A, an excessive acceleration applied to sensor 100 in a direction of the X-axis causes force f101 and f102 to be applied to weight 103 and projection 105.

FIG. 12B is a sectional view of still another comparative example, sensor 120a. In FIG. 12B, components identical to those of sensor 100 shown in FIG. 12A are dented by the same reference numerals. In sensor 120a, projections 105 and 106 are exposed from weight 103 viewing from above, namely, in a top view, so that edges of projections 105 and 106 are located outside weight 103. When an excessive acceleration caused by an impact applied to sensor 120a in the positive direction along the X-axis, a contact point between projection 106 and weight 103 receives force f120 in a direction of the X-axis due to the rotation of weight 103 in direction R803. Force f120 causes weight 103 to shift in the negative direction of the X-axis.

On the other hand, in sensor 100 shown in FIG. 12A in accordance with Embodiment 4, when an excessive acceleration due to an impact is applied to sensor 100 in the positive direction of the X-axis, a contact point between projection 106 and weight 103 receives two forces, namely, force f101 acts on projection 106 in the X-axis direction, and force f102 acts on weight 103 as reaction to force f101, thereby preventing weight 103 from shifting in the negative direction of the X-axis.

Sensor 100 in accordance with Embodiment 4 includes distortion-sensitive resistances in detectors 107 and 108 provided on beam 104 for detecting acceleration. However, an electrostatic capacitance type sensor for detecting a change in electrostatic capacitance may form projections 105 and 106 preventing weight 103 from being displaced, and can produce a similar advantage.

### Exemplary Embodiment 5

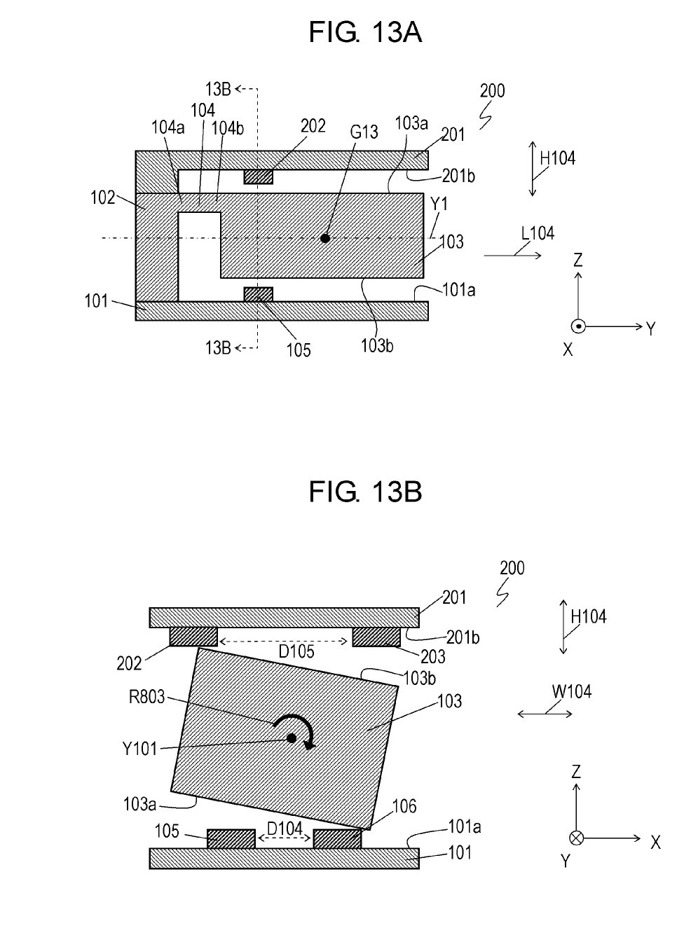

FIG. 13A is a sectional view of sensor 200 in accordance with Exemplary Embodiment 5. FIG. 13B is a sectional view of sensor 200 along line 13B-13B shown in FIG. 13A. In FIGS. 13A and 13B, components identical to those of sensor 100 shown in FIGS. 9A-11A in accordance with Embodiment 4 are denoted by the same reference numerals. Sensor 200 further includes substrate 201 connected to supporter 102 of sensor 100 in accordance with Embodiment 4, and includes projections 202 and 203 provided on lower surface 201b of substrate 201. Substrate 201 is rigidly mounted so as not to move with respect to substrate 101. Weight 103 is disposed between upper surface 101a of substrate 101 and lower surface 201b of substrate 201. Upper surface 103a of weight 103 faces lower surface 201b of substrate 201. Projections 202 and 203 face upper surface 103a of weight 103. Interval D105 between projections 202 and 203 in width direction W104 is larger than width D102 of beam 104 in width direction W104 but is smaller than width D101 of weight 103 in width direction W104. Interval D105 is a distance between respective surfaces of projections 202 and 203 facing each other. Viewing from above, each of projections 202 and 203 includes a portion exposed from weight 103 and a portion not exposed from weight 103.

A positional relation among projections 105 and 106 disposed on upper surface 101a of substrate 101, weight 103, and beam 104 is identical to that of sensor 100 in accordance with Embodiment 4.

Sensor 200 in accordance with Embodiment 5 includes projections 105 and 106 configured to contact lower surface 103b of weight 103. Corners of upper surface 103a of weight 103 are configured to contact either one of projections 202 and 203. This structure prevents more positively weight 103 from further rotating, so that beam 104 can be prevented from breaking due to the twisting of beam 104 caused by the rotation of weight 103.

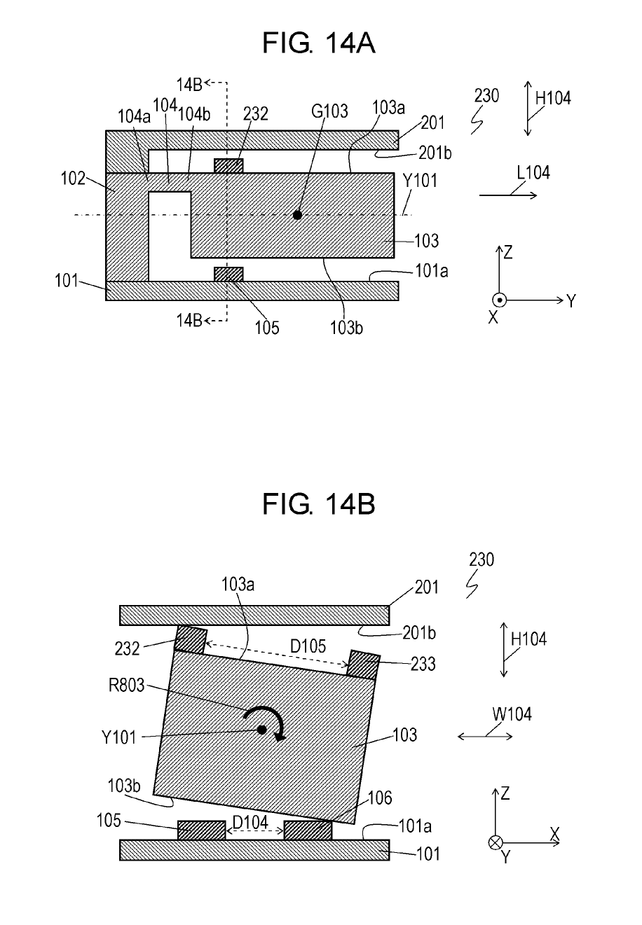

FIG. 14A is a sectional view of another sensor 230 in accordance with Embodiment 5. FIG. 14B is a sectional view of sensor 230 along line 14B-14B shown in FIG. 14A. In FIGS. 14A and 14B, components identical to those of sensor 200 shown in FIGS. 13A and 13B are denoted by the same reference numerals. Sensor 230 shown in FIGS. 14A and 14B includes projections 232 and 233 disposed on upper surface 103a of weight 103 facing lower surface 201b of substrate 201 instead of projections 202 and 203 provided on lower surface 201b of substrate 201 of sensor 200 shown in FIGS. 13A and 13B. This structure produces an advantage similar to that of sensor 200. The relation between projections 232 and 233 disposed on upper surface 103a of weight 103 and projections 105 and 106 disposed on upper surface 101a of substrate 101 may be preferably similar to that of sensor 100 in accordance with Embodiment 4.

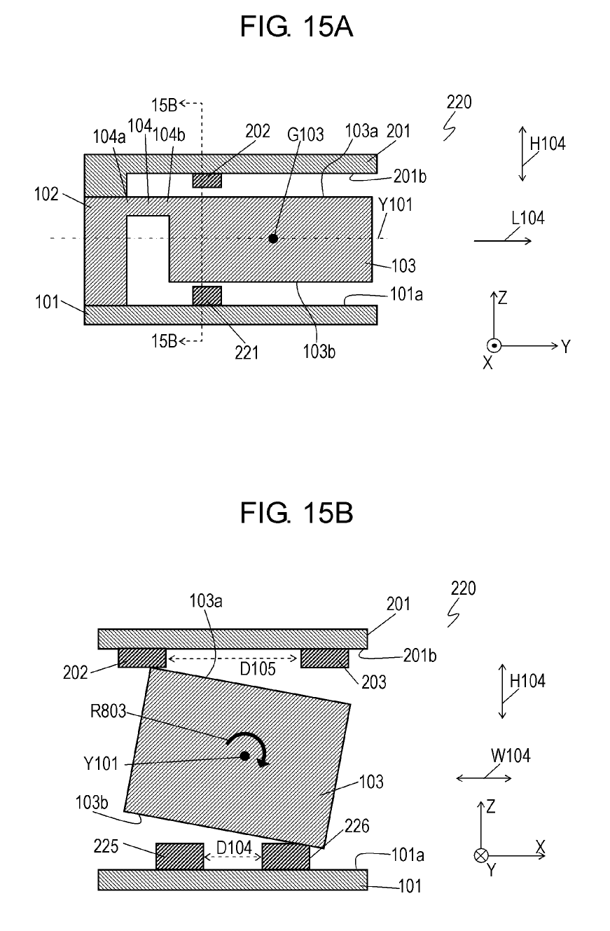

FIG. 15A is a sectional view of still another sensor 220 in accordance with Embodiment 5. FIG. 15B is a sectional view of sensor 220 along line 15B-15B shown in FIG. 15A. In FIGS. 15A and 15B, components identical to those of sensor 200 shown in FIGS. 13A and 13B are denoted by the same reference numerals. In sensor 200 shown in FIGS. 13A and 13B, projections 202 and 203 have heights in height direction H104 are equal to heights of projections 105 and 106 disposed on upper surface 101a of substrate 101 in height direction H104. In sensor 220 shown in FIGS. 15A and 15B, projections 202 and 203 has heights in height direction H104 perpendicular to upper surface 101a of substrate 101 is different from the heights of projections 225 and 226 in height direction H104. To be more specific, the heights of projections 225 and 226 in height direction H104 along the Z-axis are larger than the heights of projections 202 and 203 in height direction H104. When weight 103 rotates about axis Y101, this structure allows a rotational angle by which lower surface 103b of weight 103 contacts either one of projections 225 and 226 to be equal to a rotational angle by which upper surface 103a of weight 103 contacts either one of projections 202 and 203. This mechanism reduces stress caused by useless rotation.

### Exemplary Embodiment 6

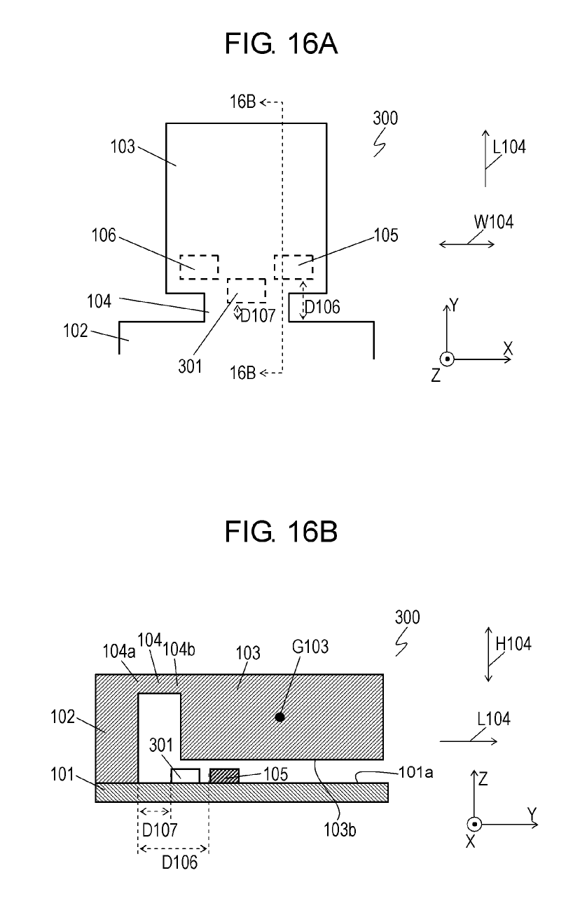

FIG. 16A is a top view of sensor 300 in accordance with Exemplary Embodiment 6. FIG. 16B is a sectional view of sensor 300 along line 16B-16B shown in FIG. 16A. In FIGS. 16A and 16B, components identical to those of sensor 100 shown in FIGS. 9A-11A in accordance with Embodiment 4 are denoted by the same reference numerals. Sensor 300 further includes projection 301 disposed on upper surface 101a of substrate 101 of sensor 100 in accordance with Embodiment 4. Projection 301 is located between projection 105 and projection 106 in width direction W104. Projection 301 prevents weight 103 from excessively shifting in a direction of the Y-axis.

As shown in FIGS. 16A and 16B, distance D106 between supporter 102 and each of projections 105 and 106 in extending direction L104 is larger than distance D107 between supporter 102 and projection 301 in extending direction L104. Projections 105 and 106 are disposed closer to center G103 of gravity of weight 103 than projection 301. An impact applied to sensor 300 causes weight 103 to contact projection 105 or 106, so that weight 103 may rotate about center G103 of gravity of weight 103. Projections 105, 106, and 301 prevents thin beam 104 from being broken due to the rotation of weight 103. In the case that projections 105 and 106 are located at a position from center G103 of gravity in extending direction L104, a movable space of weight 103 in directions of the Z-axis becomes smaller. Projections 105 and 106 may be preferably disposed in a direction opposite to extending direction L104 and closer to supporter 102 than center G103 of gravity.

Projection 301 prevents weight 103 from shifting in extending direction L104, namely, in a direction of the Y-axis while projections 105 and 106 reduces a rotational angle of weight 103 caused by an acceleration applied to sensor 300 in width direction W104, namely, in a direction of the X-axis.

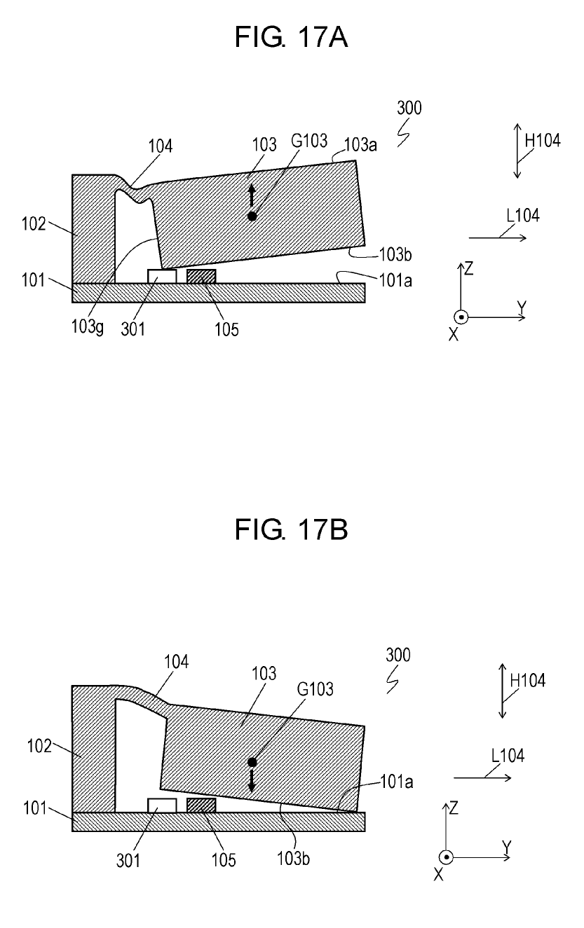

FIGS. 17A and 17B are sectional views of sensor 300. FIG. 17A illustrates that an acceleration caused by an excessive impact is applied to sensor 300 in extending direction L104, namely, in the positive direction of the Y-axis, thereby displacing weight 103. At this moment, an end of weight 103 in extending direction L104 is displaced upward, namely, in the positive direction along the Z-axis, and another end of weight 103 in the direction opposite to extending direction L104 is displaced downward, namely, in the negative direction along the Z-axis. In this case, since projection 301 is disposed in the direction opposite to extending direction L104 from center G103 of gravity of weight 103, a corner of weight 103 contacts the upper surface of projection 301, thereby effectively preventing weight 103 from being excessively displaced. Projection 301 close to the root of weight 103 among others is effective since the root tends to receive a large displacement in a direction of the Z-axis. To be more specific, projection 301 is preferably disposed beyond surface 103g of weight 103 facing supporter 102. This position of projection 301 positively prevents the root of weight 103 from being displaced excessively in the negative direction of the Z-axis. In other words, viewing from above, namely, in a top view, projection 301 preferably has a portion exposed from weight 103 and another portion not exposed from weight 103.

FIG. 17B illustrates that an acceleration caused by an excessive impact is applied to sensor 300 upward, namely, in the positive direction of the Z-axis. As shown in FIG. 17B, projections 105 and 106 are disposed closer to center G103 of gravity than projection 301. Even when the excessive impact causes an end of lower surface 103b of weight 103 in extending direction L104 to contact substrate 101, lower surface 103b preferably contact none of projections 105, 106, and 301. This structure effectively prevents weight 103 from being displaced further downward, namely, in the negative direction along the Z-axis.

The above positions of the projections allows an end of weight 103 in extending direction L104 to contact substrate 101 firstly in response to an excessive acceleration, so that projections 105, 106, and 301 may not restrict the movement of weight 103 in a regular usage for detecting an acceleration. These projections only prevent weight 103 from a displacement caused by an excessive acceleration. These projections can be formed in a single manufacturing step, thereby simplifying processes of manufacturing sensor 300.

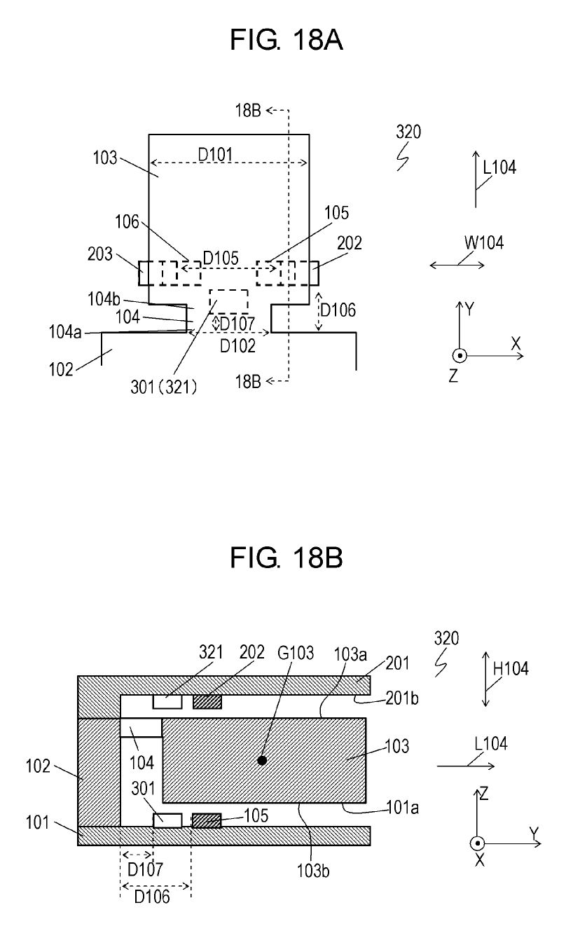

FIG. 18A is a top view of another sensor 320 in accordance with Embodiment 6. FIG. 18B is a sectional view of sensor 320 along line 18B-18B shown in FIG. 18A. In FIGS. 18A and 18B, components identical to those of sensor 300 shown in FIGS. 16A-17B and sensor 200 shown in FIGS. 13A and 13B are denoted by the same reference numerals. Sensor 320 shown in FIGS. 18A and 18B further includes substrate 201 connected to supporter 102 of sensor 300 shown in FIGS. 16A-17B, and projection 321 disposed on lower surface 201b of substrate 201 facing weight 103. Projection 321 is located between projection 202 and projection 203 in width direction W104. FIG. 18A does not show substrate 101 and substrate 201. Projection 321 disposed on lower surface 201b of substrate 201 and projection 301 disposed on upper surface 101a of substrate 101 are placed symmetrically to each other with respect to weight 103. Interval D105 between projection 202 and projection 203 in width direction W104 is larger than width D102 of beam 104 in width direction W104, and is smaller than width D101 of weight 103 in width direction W104. Interval D105 is a distance between respective surfaces of projections 202 and 203 facing each other. Projection 301 disposed under the weight 103 prevents an excessive displacement of weight 103 due to an impact applied along the Y-axis. Projections 105, 106 disposed under weight 103 prevent a rotation of weight 103 in a direction of the X-axis. This structure substantially improves the anti-impact property of sensor 320.

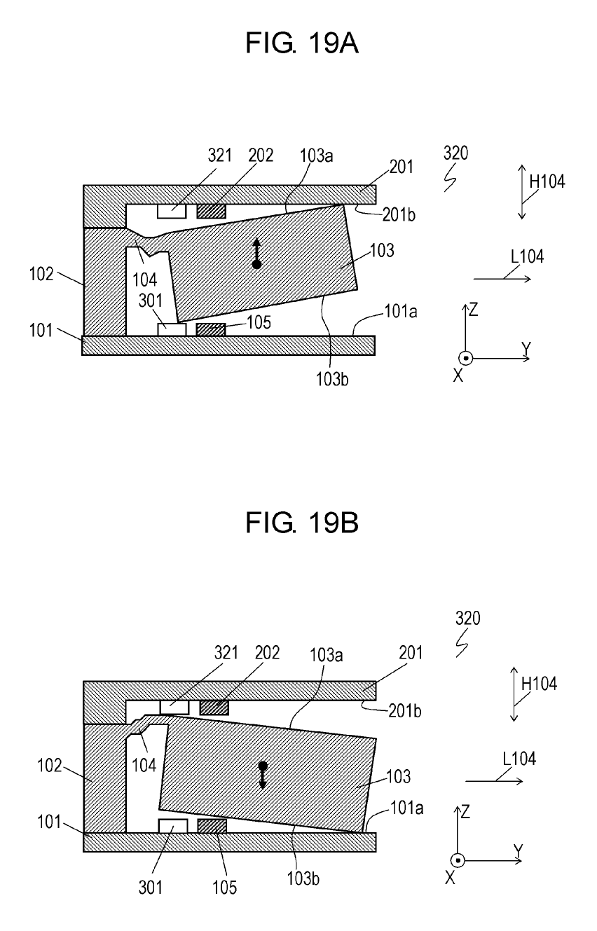

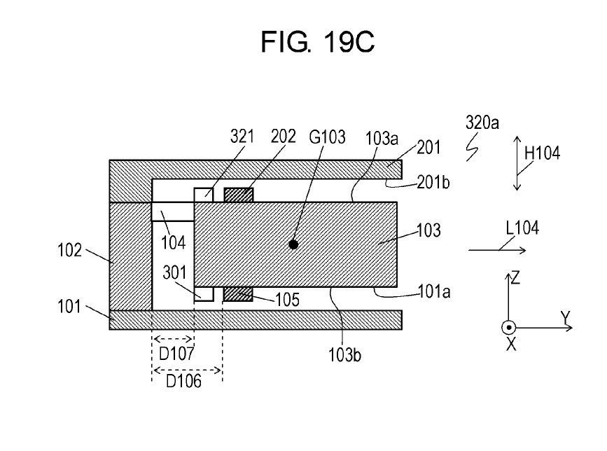

FIG. 19A is a sectional view of sensor 320 for illustrating that an acceleration caused by an excessive impact along extending direction L104, namely, in the positive direction along the Y-axis, is applied to sensor 320 to displace weight 103. In this case, an end of weight 103 in extending direction L104 is displaced upward, namely, in the positive direction along the Z-axis, and another end of weight 103 in a direction opposite to extending direction L104 is displaced downward, namely, in the negative direction along the Z-axis. At this moment, as shown in FIG. 19A, an end of upper surface 103a of weight 103 in extending direction L104 contacts substrate 201, and upper surface 103a preferably contacts none of projections 202, 203 and 321. When an excessive acceleration is applied to sensor 320 to displace weight 103 upward, namely, in the positive direction along the Z-axis, projection 202 or 203 effectively prevents weight 103 from being displaced upward, namely, in the positive direction along the Z-axis.

FIG. 19B is a sectional view of sensor 320 for illustrating that an acceleration caused by an excessive impact is applied downward to sensor 320, namely, in the negative direction along the Z-axis. In this case, since projection 321 is disposed under an end of weight 103 in the direction opposite to extending direction L104, the end of weight 103 in the opposite direction to extending direction L104 contacts a lower surface of projection 321. Projection 321 thus prevents effectively weight 103 from an excessive displacement.

Since sensor 320 shown in FIGS. 18A and 18B includes substrate 201 having projections 202 and 321 disposed thereon, projections 202 and 321 can prevent weight 103 more positively from a displacement in height direction H104, namely, in a direction of the Z-axis caused by an excessive acceleration than sensor 300 shown in FIG. 17A and including only substrate 101 having projection 301 disposed thereon.

FIG. 19C is a sectional view of further sensor 320a in accordance with Embodiment 6. In FIG. 19C, components identical to those of sensor 320 shown in FIGS. 18A and 18B are denoted by the same reference numerals. Sensor 320a shown in FIG. 19C includes projections 202, 203, and 321 not on lower surface 201b of substrate 201 but on upper surface 103a of weight 103. Upper surface 103a faces lower surface 201b. The positional relation among supporter 102, weight 103, and projections 202, 203, and 321 in sensor 320a stays the same as that in sensor 320 shown in FIGS. 18A and 18B, so that sensor 320a can produce an advantage similar to sensor 320. If the positions of projections 202, 203, and 321 and weight 103 change due to variations in manufacturing processes, projections 202, 203, and 321 on upper surface 103a of weight 103 maintain the relative positions among projections 202, 203, 321 and weight 103. This structure positively prevents weight 103 from further rotating or excessively being displaced.

### Exemplary Embodiment 7

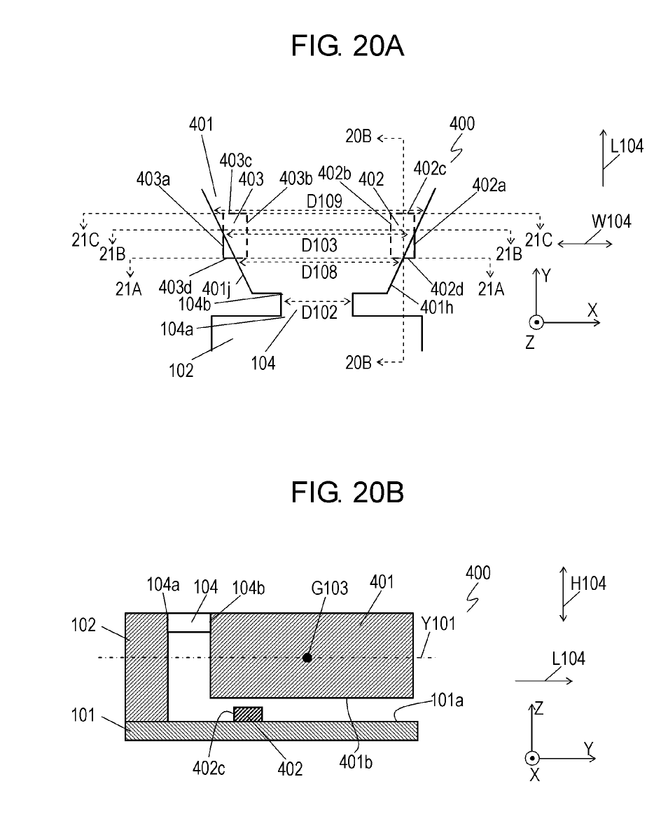

FIG. 20A is a top view of sensor 400 in accordance with Exemplary Embodiment 7. FIG. 20B is a sectional view of sensor 400 along line 20B-20B shown in FIG. 20A. In FIGS. 20A and 20B, components identical to those of sensor 100 shown in FIG. 9A and 9B in accordance with Embodiment 4 are denoted by the same reference numerals. Sensor 400 includes weight 401 connected to second end 104b of beam 104, and projections 402 and 403 disposed on upper surface 101a of substrate 101 instead of weight 103 of sensor 100 and projections 105 and 106 of sensor 100 in accordance with Embodiment 4. FIG. 20A does not show substrate 101. Viewing from above, namely, in a top view, weight 401 has edges 401h and 401j inclining with respect a direction of the Y-axis, namely, in extending direction L104 of beam 104.

Viewing from the above, namely, in a top view, each of projections 402 and 403 includes a portion exposed from weight 401 and another portion not disposed from weight 401. Viewing from above, namely, in a top view, edge 402a of projection 402 crosses edge 401h of weight 401, and edge 403a of projection 403 crosses edge 401j of weight 401. Edges 402a and 403a of projections 402 and 403 extend in extending direction L104.

Sensor 400 will be detailed below. Sensor 400 includes weight 400 having lower surface 401b facing upper surface 101a of substrate 101, and includes projections 402 and 403 disposed on upper surface 101a of substrate 101. Projections 402 and 403 are arranged in width direction W104. Edge 401h of weight 401 is not parallel with edge 402a of projection 402. Edges 401h and 402a extend in directions different from each other. Edge 401j of weight 401 is not parallel with edge 403a of projection 403. Edges 401j and 403a extend in directions different from each other. Edge 401h of weight 401 is not parallel with edge 401j. Edges 401h and 401j extend in directions different from each other. Projection 402 has edge 402c facing supporter 102, and has edge 402d opposite to edge 402c. Edge 402d is disposed in extending direction L104 from edge 402c. Edge 402a is connected to edges 402c and 402d. Projection 403 has edge 403c facing supporter 102, and has edge 403d opposite to edge 403c. Edge 403a is connected to edges 403c and 403d. Edge 403d is disposed in extending direction L104 from edge 403c. Weight 401 has a portion facing edges 402c and 403c of projections 402 and 403 in height direction H104. Width D108 of the portion of weight 401 in width direction W104 is larger than width D102 of beam 104 in width direction W104. Width D108 is smaller than distance D103 between projections 402 and 403 in width direction W104. Projections 402 and 403 have edges 402b and 403b facing each other in width direction W104, respectively. Projection 402 has edge 402a opposite to edge 402b in width direction W104. Projection 403 has edge 403a opposite to edge 403b in width direction W104. Distance D103 is a distance between edge 402a of projection 402 and edge 403a of projection 403. Weight 401 has a portion facing edges 402a and 403a of projections 402 and 403 in height direction H104. Width D109 of the portion of weight 401 is larger than distance D103 between projections 402 and 403.

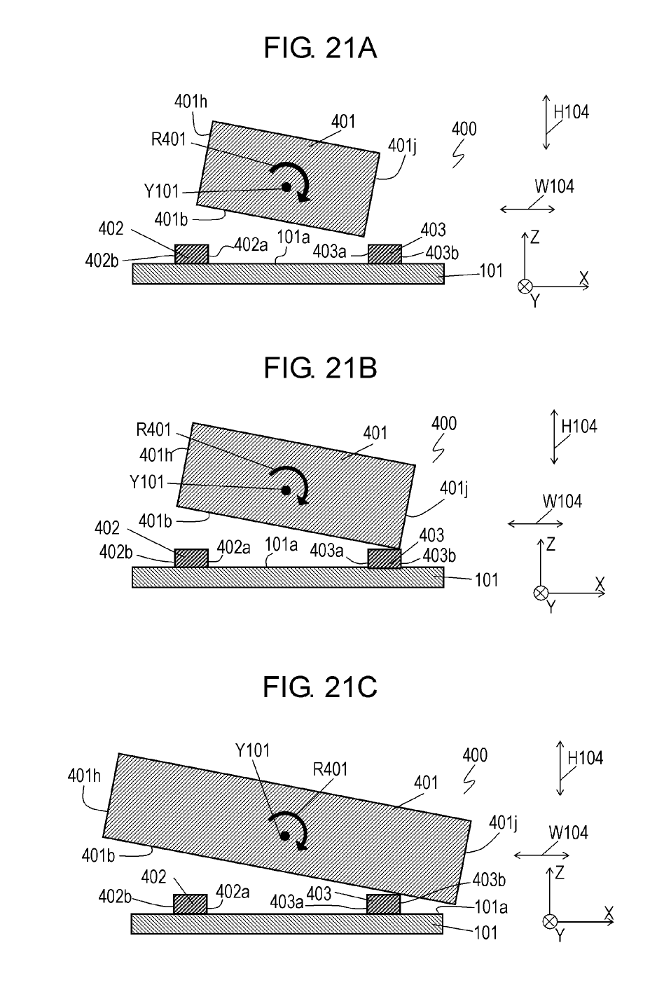

Next, an operation of sensor 400 having an excessive acceleration caused by an impact applied to sensor 400 in extending direction L104, namely, in the positive direction along the X-axis, will be described below. FIG. 21A is a sectional view of sensor 400 along line 21A-21A shown in FIG. 20A. Viewing from above, namely, in a top view, line 21A-21A shown in FIG. 20A extends along edges 402d of projection 402 and edges 403d of projection 403, and passes through portions of projections 402 and 403 not exposed from weight 401, but line 21A-21A does pass run through portions of projections 402 and 403 exposed from weight 401. The acceleration causes weight 401 to rotate about axis Y101 which is parallel to the Y-axis and passes through center G401 of gravity of weight 401 in direction R401. The sectional view along line 21A-21A illustrates that weight 401 contacts none of projections 402 and 403. FIG. 21B is a sectional view of sensor 400 along line 21B-21B shown in FIG. 20A. Viewing from above, namely, in a top view, line 21B-21B shown in FIG. 20A passes through a point where edge 402a of projection 402 crosses edge 401h of weight 401, and a point where edge 403a of projection crosses edge 401j of weight 401. The sectional view along line 21B-21B illustrates that, when weight 401 rotates due to the acceleration in direction R401, edge 401j of weight 401 contacts edge 403a of projection 403, thereby restricting the rotation of weight 401 in direction R104. When weight 401 rotates in a direction opposite to direction R401, weight 401 contacts edge 402a of projection 402, thereby restricting the rotation. FIG. 21C is a sectional view of sensor 400 along line 21C-21C shown in FIG. 20A. Viewing from above, namely, in a top view, line 21C-21C shown in FIG. 20A extends along edge 402c of projection 402 and edge 403c of projection 403, and passes through portions of projections 402 and 403 exposed from weight 401 as well as portions of projections 402 and 403 not exposed from weight 401. The sectional view along line 21C-21C illustrates that weight 401 rotates in direction R401 due to the acceleration, and lower surface 401b of weight 401 contacts edge 403a of projection 403 in a region where weight 401 overlaps projection 403 viewing from above, namely, in a top view, thereby restricting the rotation of weight 401 in direction R401. When weight 401 rotates in the direction opposite to direction R401, weight 401 contacts edge 402a of projection 402, thereby restricting the rotation. These restrictions of the rotation of weight 401 prevent beam 104 from excessively twisting due to the rotation, thereby preventing beam 104 from being broken. As discussed above, in the region where weight 401 overlaps projection 403 viewing from above, namely, in the top view, weight 401 rotates and contacts edge 402a of projection 402 or edge 403a of projection 403. This structure restricts the rotation of weight 401 more easily than a case that projection 402 or 403 contacts weight 401 in an XY plane that extends along the X-axis (extending direction L104) and the Y-axis (width direction W104). This structure prevents weight 401 from sticking to projection 402 or 403.

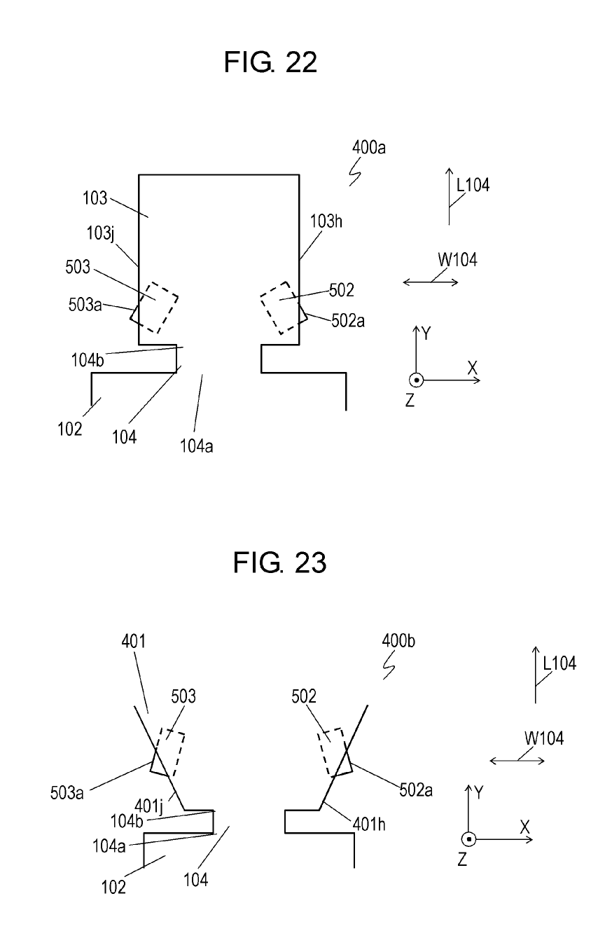

FIG. 22 is a top view of another sensor 400a in accordance with Embodiment 7. In FIG. 22, components identical to those of sensor 100 shown in FIGS. 9A and 9B and in accordance with Embodiment 4 are denoted by the same reference numerals. Sensor 400a includes projections 502 and 503 disposed on upper surface 101a of substrate 101 instead of projections 105 and 106 of sensor 100 shown in FIGS. 9A and 9B.

In sensor 400 shown in FIGS. 20A and 20B, edges 401h and 401j of weight 401 incline with respect to extending direction L104, and edges 402a and 403a extend in extending direction L104. Viewing from above, namely, in a top view, edges 402a and 403a of projections 402 and 403 cross edges 401h and 401j of weight 401, respectively.

In sensor 400a shown in FIG. 22, edges 103h and 103j of weight 103 extend in extending direction L104. Viewing from above, namely, in a top view, each of projections 502 and 503 includes a portion exposed from weight 103 and another portion not exposed from weight 103. Projections 502 and 503 have edges 502a and 503a inclining with respect to extending direction L104. Viewing from above, namely, in a top view, edge 502a of projection 502 crosses edge 103h of weight 103, and edge 503a of projection 503 crosses edge 103j of weight 103. This structure provides sensor 400a with an advantage similar to that of sensor 400 shown in FIGS. 20A and 20B.

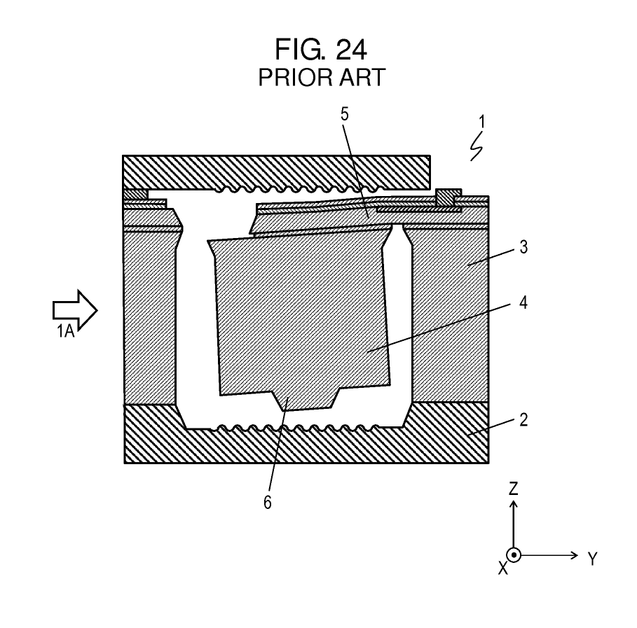

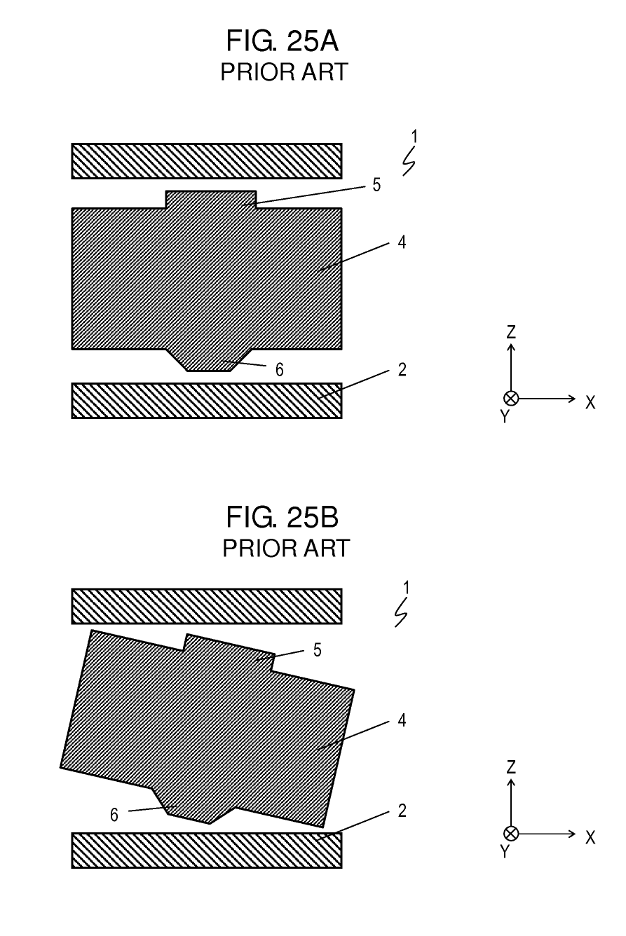

FIG. 23 is a top view of still another sensor 400b in accordance with Embodiment 7. In FIG. 23, components identical to those of sensor 400 shown in FIGS. 20A and 20B and sensor 400a shown in FIG. 22 in accordance with Embodiment 7 are denoted by the same reference numerals. Sensor 400b includes projections 502 and 503 of sensor 400a shown in FIG. 22 instead of projections 402 and 403 of sensor 400 shown in FIGS. 20A and 20B.

In sensor 400b shown in FIG. 23, edge 502a of projection 502 inclines with respect to extending direction L104 and in a direction opposite to edge 401h of weight 401. Edge 503a of projection 503 inclines with respect to extending direction L104 and in a direction opposite to edge 401j of weight 401. Viewing from the above, namely, in a top view, edge 502a of projection 502 crosses edge 103h of weight 103, and edge 503a of projection 503 crosses edge 103j of weight 103. This structure provide sensor 400b with an advantage similar to those of sensor 400 shown in FIGS. 20A and 20B and sensor 400a shown in FIG. 22.

The sensors in accordance with Embodiments 1-7 are acceleration sensors; however, a sensor as long as detecting a physical quantity by using a rotation or a displacement of a weight can be applied to other sensors, such as angular sensor, distortion sensor, barometric sensor, and pressure sensor.

In the previous embodiments, terms, such as “upper surface”, “lower surface”, “above”, and “under” indicating directions merely indicate relative directions depending on only relative positional relations among the structural elements, such as a substrate and a weight, of the sensors, and do not indicate absolute directions, such as a vertical direction.

### INDUSTRIAL APPLICABILITY

A sensor according to the present invention can effectively prevent a beam from being broken due to a twist caused by a rotation of a weight, thereby improving anti-impact property of the sensor. The sensor is thus useful as an inertial sensor including an acceleration sensor or an angular sensor, and a distortion sensor, a barometric sensor to be used in vehicles, navigation devices, and portable terminals.

### REFERENCE MARKS IN THE DRAWINGS

11 substrate

12 supporter

13 weight

14 beam

16, 16, 20, 22, 23, 31, 32 projection

17, 18 detector

21 substrate

101 substrate (first substrate)

102 supporter

103 weight

104 beam

105 projection (first projection)

106 projection (second projection)

201 substrate (second substrate)

202 projection (third projection)

203 projection (fourth projection)

401 weight

402 projection (first projection)

403 projection (second projection)

502 projection (first projection)

503 projection (second projection)

W14 width direction

L14 extending direction

H14 height direction

W104 width direction

L104 extending direction

H104 height direction

1. A sensor comprising:
a first substrate;
a supporter connected to the first substrate;
a weight facing the first substrate;
a beam having a first end and a second end, the first end being connected to the supporter, the second end being connected to the weight;
a second substrate facing the weight;
a first projection disposed on the first substrate;
a second projection disposed on the first substrate;
a third projection disposed on the second substrate; and
a fourth projection disposed on the second substrate,
wherein an interval between the first projection and the second projection is smaller than an interval between the third projection and the fourth projection.

2. The sensor according to claim 1, wherein, in a top view, the first projection and the second projection are not exposed from the weight.

3. The sensor according to claim 1, wherein, in the top view, a portion of the third projection and a portion of the fourth projection are exposed from the weight.

4. The sensor according to claim 3, wherein a thickness of the third projection and a thickness of the fourth projection are larger than a thickness of the first projection and a thickness of the second projection.

5. The sensor according to claim 4, wherein the interval between the first projection and the second projection is larger than a width of the beam.

6. The sensor according to claim 4, wherein the interval between the third projection and the fourth projection is larger than a width of the beam.

7. The sensor according to claim 1, wherein, in a top view, the first projection has an edge crossing an edge of the weight.

8. The sensor according to claim 7,
wherein the edge of the weight inclines with respect to an extending direction of the beam, and
wherein the edge of the first projection extends in the extending direction.

9. The sensor according to claim 1,
wherein the beam extends from the first end to the second end in an extending direction, and
wherein a width of the weight in a width direction parallel to the first substrate and perpendicular to the extending direction is larger than an interval between the first projection and the second projection in the width direction, and is larger than an interval between the third projection and the fourth projection in the width direction.

10. The sensor according to claim 9, wherein the interval between the first projection and the second projection in the width direction is smaller than the interval between the third projection and the fourth projection in the width direction.

11. A sensor comprising:
a substrate;
a supporter connected to the substrate;
a beam having a first end and a second end opposite to the first end, the first end being connected to the supporter, the beam extending from the first end in an extending direction;
a weight facing the substrate; and
a first projection disposed on the substrate,
wherein the weight has an edge inclining with respect to the extending direction,
wherein the first projection has an edge extending in the extending direction, and
wherein, in a top view, the first projection includes a portion exposed from the weight and a portion not exposed from the weight.

12. The sensor according to claim 11, further comprising
a second projection disposed on the substrate,
wherein the second projection has an edge extending in a direction different from a direction in which the edge of the weight extends, and
wherein the second projection includes a portion exposed from the weight and a portion not exposed from the weight.

13. A sensor comprising:
a first substrate;
a supporter connected to the first substrate;
a weight facing the first substrate;
a beam having a first end and a second end, the first end being connected to the supporter, the second end being connected to the weight;
a second substrate facing the weight;
a first projection disposed on the first substrate; and
a second projection disposed on the second substrate,
wherein a thickness of the first projection is different from a thickness of the second projection.

14. A sensor comprising:
a substrate;
a supporter disposed on an upper surface of the substrate;
a weight facing the upper surface of the substrate;
a beam having one end and another end, the one end being connected to the supporter, the another end being connected to the weight; and
a first projection, a second projection, and a third projection which are disposed on the upper surface of the substrate or on a lower surface of the weight,
wherein the weight has a width larger than a width of the beam,
wherein an interval between the first projection and the second projection is larger than the width of the beam, and is smaller than the width of the weight,
wherein the third projection is disposed between the first projection and the second projection, and is closer to the supporter than the first projection and the second projection, and
wherein a border between the weight and the beam is located above the third projection.

15. The sensor according to claim 14, wherein a projection gap ratio H2/H1 which is a ratio of a distance H2 between the lower surface of the weight and each of an upper surface of the first projection and an upper surface of the second projection to a distance H1 between the upper surface of the substrate and the lower surface of the weight ranges from 0.3 to 0.5.

16. The sensor according to claim 14, wherein the first projection and the second projection are closer to the supporter than a center of gravity of the weight.

17. The sensor according to claim 14, wherein in a top view from above an upper surface of the weight, a portion of the first projection and a portion of the second projection are exposed from the weight.

18. The sensor according to claim 14, further comprising:
an upper substrate facing an upper surface of the weight; and
a fourth projection and a fifth projection which are disposed on a lower surface of the upper substrate or on the upper surface of the weight,
wherein an interval between the fourth and the fifth projections is larger than the width of the beam, and yet, smaller than the width of the weight.

19. The sensor according to claim 18, further comprising
a sixth projection,
wherein the sixth projection is disposed between the fourth projection and the fifth projection, and is closer to the supporter than the fourth projection and the fifth projection.

20. The sensor according to claim 18, wherein the fourth projection and the fifth projection are closer to the supporter than a center of gravity of the weight.

21. The sensor according to claim 18, wherein, in a top view from above the upper surface of the weight, a portion of the fourth projection and a portion of the fifth projection are exposed from the weight.
